(19) United States
(12) Patent Application Publication
(10) Pub. No.: US 2010/0287073 A1
(43) Pub. Date: Nov. 11, 2010

(54) METHOD FOR OPTIMIZING A TRANSPORTATION SCHEME

(75) Inventors: Gary R. KOCIS, Vienna, VA (US); Kevin C. Furman, Houston, TX (US); Mark Osmer, Montclair, VA (US); Jin-Hwa Song, Whitehouse Station, NJ (US); Philip H. Warrick, Oakton, VA (US); Thomas A. Wheaton, Alexandria, VA (US); LeonaAnn Chua, Singapore (SG); Felix Liok, Singapore (SG)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 12/770,393

(22) Filed: Apr. 29, 2010

Related U.S. Application Data
(60) Provisional application No. 61/175,718, filed on May 5, 2009.

(51) Int. Cl. G06Q 10/00; G06Q 50/00

(52) U.S. Cl. 705/28; 705/338

(57) ABSTRACT

A method and apparatus for optimal transporting of cargo is provided. The method includes optimizing a plurality of transportation decisions and mechanically transporting cargo through movement of a plurality of vehicles in accordance with a set of optimized transportation decisions. The decisions include transportation routes and schedules for the transportation vehicles, allocation of cargo to be transported to one or more demand locations by the transportation vehicles, nomination of cargo pickup by the transportation vehicles from the one or more supply locations, the use of specialized transportation locations, and vehicle assignments for each of the transportation vehicles. The set of decisions is optimized by collecting data relating to the various transportation decisions, using the data collected as part of a mixed integer linear programming model, and obtaining a solution to the model to arrive at a set of optimized transportation decisions.

### CROSS REFERENCE TO RELATED APPLICATIONS

This application claims the benefit of provisional U.S. Patent Application No. 61/175,718 (filed 5 May 2009), which is incorporated by reference herein in its entirety. This application also relates to U.S. patent application Ser. No. 12/285,651, entitled “System for Optimizing Transportation Scheduling,” filed Oct. 12, 2008 which, in turn, relates to U.S. Provisional Patent Application No. 60/996,188 of the same title filed Nov. 6, 2007. This application also relates to U.S. patent application Ser. No. 12/292,600, filed Nov. 21, 2008, entitled “System for Optimizing Bulk Allocation, Transportation and Blending” which, in turn, relates to U.S. Provisional Patent Application No. 61/008,581, of the same title, filed Dec. 21, 2007. The entirety of each of these applications are incorporated herein by reference.

### BACKGROUND OF THE INVENTION

1. Field of the Invention

This invention is directed to a method for determining an optimized transportation scheme for a plurality of transportation vehicles and moving the vehicles according to said scheme. The invention is also directed to an apparatus for determining an optimized set of transportation decisions. More particularly, the invention is directed to determining an optimal solution to maximize total net margin for a cargo loading and delivery program by determining a set of voyages for transporting cargo comprising one or more bulk materials and assigning vehicles in an available fleet to perform the voyages during a given planning period.

2. Description of Related Art

Marine transportation is an important aspect for many industries including the oil and gas industry. Marine transportation is an economically attractive means to vessel bulk material (e.g., bulk liquids such as crude oil) over long distances. Accordingly, large volumes of bulk material are moved daily across the oceans and seas by a variety of vessels between source and destination locations. Destination ports (e.g., refinery sites) may be geographically spread around the world and are often far from the source of the bulk material (e.g., crude oil) needed. Because distances are large, transportation costs are significant. For example, in 2008 one major company's marine activities included over 30,000 voyages totaling nearly $5 billion in freight costs. In addition, the business environment of marine transportation is complex and dynamic in that the number of shipping options is large and varies at any given time depending upon the amount of material that needs to be transported, temporal restrictions for the transport, the physical limitations of available vessels and relevant ports, vessel contractual terms and conditions, etc. Accordingly, marine transportation scheduling decisions are complex and dynamic.

The conventional commercial practice for making vessel transportation decisions is to perform a manual analysis of available options. An experienced staff will calculate voyage constraints, estimate economic trade-offs, project voyage events forward in time and evaluate potential decisions. The staff may also apply heuristics, business rules and guidelines, and intuition to develop an acceptable cargo transportation (i.e., lifting) program. The process is time consuming, incomplete, and there is no realistic way to know whether the lifting program chosen is optimal. Given the typically large number of feasible voyages, schedules, and vessel/voyage assignments, it is very difficult, if not impossible, to determine an optimal lifting program by manually considering one voyage (or one vessel) at a time. This difficulty is further compounded due to interactions between the various assignment decisions. (For example, if a given vessel is assigned to a given voyage, then the vessel is no longer available for one or more alternate concurrent voyages.) The number of interactions, the number of possible decisions, and the number of significant factors are far too complex to be fully optimized manually (particularly in an acceptable time frame for making business decisions) even by an experienced scheduler. The problem is further complicated as one attempts to account for sequences of one or more voyages that can be assigned to a given vessel. In addition, once a manually derived set of voyages and schedule has been completed, it is impractical to frequently repeat the scheduling process to reflect changes in the business environment which can occur daily or to run several different scenarios to test the effect a particular constraint may have on the overall lifting program.

TurboRouter® is a tool recently developed by the Norwegian Marine Technology Research Institute, MARINTEK Logistics, and it performs vessel routing and scheduling calculations. However, the tool is based on a heuristic approach rather than an optimization approach. In addition, the purpose of the tool is to allow a commercial shipping company, as opposed to a chartering party or cargo owner, to maximize the revenue obtained by shipping optional cargo in addition to contract cargos that must be shipped.

There have been numerous publications in the field of ship routing and scheduling. One survey article is Ship routing and scheduling: status and perspectives, Transportation Science, 38(1): 1-18, M. Christiansen, K. Fagerholt, and D. Ronen (2004) (the entirety of which is incorporated herein by reference). One overview article is Marine Transportation, Handbooks in Operations Research and Management Science: Transportation, M. Christiansen, K. Fagerholt, B. Nygreen, D. Ronen, edited by C. Barnhart and G. Laporte (2005) (the entirety of which is incorporated herein by reference).

One publication of note is Scheduling Ocean Transportation of Crude Oil, Management Science, G. G. Brown, G. W. Graves, D. Ronen, 33(3): 335-346 (1987) (the entirety of which is incorporated herein by reference). This paper addresses a crude oil marine transportation problem. However, the modeling problem described therein includes the following assumptions/simplifications: (1) each cargo (i.e., crude oil to be shipped) moves between a single loading port and a single discharging port; (2) the cargo shipped must always be a full ship load (i.e., the cargo must be of a fixed size); and (3) each vessel is the same size. In addition, the objective function of the model is to minimize cost rather than to maximize net margin (i.e., revenue or value minus costs).

Another publication of note is Fleet management models and algorithms for an oil tanker routing and scheduling problem, H. D. Sherali, S. M. Al-Yakoob, M. M. Hassan, IIE Trans. 31: 395-406 (1999) (the entirety of which is incorporated herein by reference). This paper also addresses a crude oil marine transportation modeling problem. Again, the modeling problem characteristics are such that each voyage must consist of a single loading port and a single discharging port and each cargo must be a full vessel load. In addition, the objective is to minimize cost rather than to maximize net margin. The problem addressed in this paper is different from the preceding paper in that the problem in that the ships do not have to be the same size and there is an explicit treatment of vessel compartments.

None of the work above provides a marine transportation scheme that represents the general vessel routing, scheduling, and assignment business problem characteristics and/or constraints. For example, in a typical vessel scheduling problem, each voyage consists of multiple loading ports and multiple discharging ports, the cargos lifted may vary in weight and/or volume, and the vessels available to perform the voyage may vary in a number of ways including, but not limited to, capacity and charter type (e.g., spot vessels and term vessels).

Further, none of the work above provides a marine transportation program that optimally maximizes the total net margin for a transportation scheme as opposed to merely minimizing cost. A cost minimization approach alone may not always provide the most adequate results, as it does not correctly represent the economic impact of vessel assignment decisions, does not properly reflect the trade-offs between the use of term and spot vessels, and does not value long and short voyages on a consistent basis.

Accordingly, as set forth below, a novel method has been developed for determining optimal transportation routing, cargo allocation, scheduling, and assignment decisions and moving a vehicle fleet in accordance with those decisions. The method determines the optimal solution to maximize total net margin for a cargo loading and delivery program by determining a set of voyages for transporting cargo comprising one or more bulk materials and assigning vehicles in an available fleet to perform the voyages while reflecting common scheduling problem characteristics and constraints. Such an optimization method has implications beyond just the marine shipping industry and is equally applicable to land (e.g., the trucking industry) and air transportation as well.

### BRIEF DESCRIPTION OF THE DRAWINGS

The present invention will become more fully understood from the detailed description given below and the accompanying drawings, which are given by way of illustration only. Thus, these drawings are not limitative of the present invention.

FIG. 1 depicts an exemplary representation of the interaction between a user and a modeling application with its various interfaces and calculation engines in one embodiment of this invention.

FIG. 2 is a representation of a portion of the functionality of an apparatus in accordance with certain embodiments of the present invention.

FIG. 3 is a representation of the steps associated with a method for moving cargo according to a set of optimized transportation decisions in accordance with certain embodiments of the present invention.

The detailed drawings are provided for the purposes of illustration only. The particular data set forth in the various illustrative spreadsheets is hypothetical but representative data for a hypothetical but representative scheduling problem. Accordingly, the results derived there from are similarly hypothetical but representative.

### SUMMARY OF THE INVENTION

This invention provides a method for optimizing various decisions associated with a transportation schedule for a plurality of transportation vehicles transporting cargo to and from various locations and moving the plurality of transportation vehicles according to the optimized decisions. More particularly, the decisions include the transportation routes (i.e., voyages), the timing and order in which the transportation routes are performed, and the ships assigned to perform each route according to the schedule and the type and amount of cargo pickup and delivery within set parameters. An apparatus capable of performing this optimization method is also provided. Although the method is particularly beneficial in the marine transportation field, the method may be applied to any known transportation field, such as those for shipping cargo by land or by air. In certain embodiments related to the transportation of bulk material cargo using marine vessels, the various decisions to be optimized include supply nominations (including supply volume, grade of bulk material, and dates), allocation of available supply to meet segregation requirements, the transportation routes (i.e. voyages) for each vessel in the plurality of vehicles, and the use of various canals (such as the Suez Canal) that incorporate repackaging, drop and pick, and pipeline considerations where appropriate.

The method comprises optimizing transportation decisions, including transportation routes for the plurality of vehicles, demand allocation for the cargo, supply nomination of cargo, and the consideration of specialized transportation options. The method further comprises moving the plurality of vehicles in accordance with the optimized transportation decisions. The optimization may be performed to maximize the total net margin of transporting cargo on the vehicles, to minimize the costs of transporting the vehicles, or to optimize some other objective function. The optimizing transportation decisions method includes: (1) collecting data relating to a plurality of supply locations, a plurality of demand locations, a plurality of transportation vehicles, cargo to be transported, transportation information, and other user-defined constraints; (2) using the data as part of a mixed integer linear programming model that comprises an objective function for maximizing net profit (or for minimizing incurred costs) and a plurality of constraints based on the data; and (3) obtaining one or more solutions to the mixed integer linear programming model. The method further comprises moving the plurality of vehicles in accordance with the optimized transportation solution.

The method determines the optimal routes to be performed and, for each optimized transportation route, the stops (e.g., supply/demand locations, canals, refueling, etc.) each vehicle makes in the route, the amount and type of cargo loaded at each supply stop, the amount and type of cargo discharged at each demand stop, the schedule for loading/discharging cargo, the estimated freight cost, and the specific vehicle assigned to the voyage. In addition, the method may determine, for each grouping of cargo at each demand location, the inventory profile and other limiting constraints on delivery (including, for example, suggested blend-down ratio of bulk material cargo). In certain embodiments, the determinations above are made using a computer application and displayed to a user through a graphical user interface (GUI) or spreadsheet for example.

The method is also able to determine the optimal solution to maximize total net margin for the determination of a set of voyages to be performed and the assignment of vehicles in an available fleet to perform the voyages. Alternatively, the optimal solution may be determined based on a minimization of incurred costs. Each voyage in the set of voyages is initiated during a planning period and outlines precisely how the various vehicles will transport cargo from one or more supply locations (e.g., loading ports) to one or more demand locations (e.g., discharging ports). In one embodiment, each vehicle may differ in size, shape, capacity, cost, and charter type (e.g., term vessels versus spot vessels).

The method considers a number of input parameters in determining the feasible options and the optimal transportation routing, schedule, and vehicle/voyage assignments to produce the highest total predicted net margin (or, alternatively, to produce the lowest total incurred cost). Typical decisions that can be considered include, but are not limited to, the following: (1) the supply and (2) demand locations (e.g., ports), which can have different physical limitations (e.g., maximum draft, maximum vessel length and width, etc.), costs (e.g., port fees), physical locations, ratability requirements, pickup/delivery timing windows (e.g., lifting laycan), processing/consumption rates of cargo, cargo type requirements/availability (e.g., crude oil grade and/or blend-down ratio restrictions), and minimum/maximum inventory restrictions; (3) the specific characteristics of each vehicle in an available fleet—such as draft, laden/ballast speeds, fuel consumption rate, vehicle locations, cargo capacity, and other parameters—that determine whether a vehicle can meet the constraints of the supply and demand locations in the voyage; (4) the different types of cargo (e.g., different grades of crude oil) being shipped and their volume, densities, or other properties; and (5) various transportation properties, such as the distance between various locations, availability of special routes (e.g., canals, which may have drop and pick and repackaging capabilities), tolls, flat rates, and fuel costs. Preferably, all problem characteristics (e.g., input parameters) with an appreciable affect on net margin or incurred cost are considered.

The method can be executed multiple times to explore sensitivities in input data, assumptions, and assignment constraints. For example, a user can force the model to assign a given vehicle to a given voyage and re-optimize the vehicle schedule using the forced assignment. This can be advantageous to represent decisions already made or to analyze the impact of forcing a vehicle assignment.

The application runs fast enough to evaluate opportunities in a dynamic business environment and to support what-if scenarios. In one embodiment, the application performs the calculations for a typical problem in about 30-45 minutes running on an unimpeded 3 GHz dual-core personal computer.

### DETAILED DESCRIPTION

### Definitions

All words in this specification are intended to have their broadest conventional meaning.

For further clarity, the conventional meaning of some terms used in this specification is set forth below.

“Allocation” means assigning available cargo to various demand locations in order to meet destination requirements on the basis of some preference (e.g., economic), while satisfying existing constraints and limitations.

“Blend-down Ratio” represents a set of constraints which limit the mix (or blend) of supply grades of bulk material (e.g., crude oil), which when delivered on a single vehicle would be acceptable for a demand location segregation (e.g., port segregation).

“Bulk material” means any material that is unbound and substantially fluid as loaded; in other words, it is in a loose unpackaged form. Examples of bulk material include coal, grain, and petroleum products.

“Cargo” means any product or material being transported by a vehicle. In a preferred embodiment, the cargo is bulk material such as crude oil.

“Code” embraces both source code and object code.

“Compulsory Stock Obligation (CSO)” typically refers to a law requiring a certain minimum volume of cargo (and/or equivalent products) to be maintained within a designated geographic region. For example, Legal Obligatory Volume (LOV) is a CSO for Japan that is calculated based on the total volume of bulk material on-shore or within the territorial waters of Japan. An analogous legal or regulatory obligation may exist for other transportation points in marine, land, or air shipping. CSO, as used herein, would also encompass these analogous processes.

“Demand location” means a place where transported cargo is received. “Discharging,” “demand,” “receiving,” and “destination” locations or sites (such as ports) are used interchangeably herein.

“Discharge program” represents the schedule for discharge activities (i.e. the delivering of cargo to demand locations) and includes a sequence of vehicles, demand locations, discharge destinations, type of cargo, discharge volume of cargo, and discharge dates for a number of discharge activities planned for a given period (e.g., one month). In certain embodiments, “discharge destinations” are segregations of bulk material at each demand location.

“Drop and Pick” arises in the context of a marine transportation application of the present invention. Certain class marine vessels—e.g., ships such as very large crude carriers (VLCCs)—cannot travel through certain canals—e.g., the Suez Canal—while fully laden with cargo. A Drop and Pick (D&P) consists of unloading enough cargo before entering the canal—e.g., at Ain Sukhna in the Red Sea—such that a ship may pass through the canal. Once having passed through the canal, the ship loads a quantity similar to (or more than) the amount discharged at the drop point. An analogous process may exist at other canals used for maritime shipping or other transportation points for land or air shipping. D&P, as used herein, would also encompass these analogous processes.

“External Supply” means the ability to represent and include the inventory effect of discharges (e.g., at a demand location) that have not been included in the loading program. This approach may be used to represent regional or local cargo supplies but is not limited solely to such use.

“Fleet” means a grouping of two or more vehicles. A fleet may be homogenous (i.e. containing only one vehicle type) or heterogeneous (i.e. containing two or more different vehicle types).

“Grade Swap” entails delivering a substitute grade of crude oil rather than the requested grade to meet a requirement for some segregation at a demand location (e.g., a demand port). It would be expected that the substation may require a different volume or weight than originally required and that the revenue or value for the substituted crude grade may be adjusted accordingly by some penalty or incentive.

“Loading program” represents the schedule for loading activities (i.e. the loading of cargo at supply locations) and includes a sequence of vehicles, supply locations, cargo type, load volume of cargo, and load dates for a number of loading activities planned for a given period (e.g., one month).

“Net margin” is revenue minus incurred cost.

“Nomination program” represents the schedule for supplying cargo to the various transportation vehicles for delivery to the demand locations. A nomination program includes supply locations, type of cargo, load volume of cargo, and load dates for a number of supply loading activities for a given period (e.g., one month).

“Optimal,” “optimizing,” “optimize,” “optimality,” “optimization,” as well as derivatives and other forms of those terms and linguistically related words and phrases as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the present invention, are more general. The terms can describe working towards a solution, or solutions (e.g., comparing two or more solutions and selecting at least a portion of at least one solution), which may be the best available solution, a preferred solution, or a solution that offers a specific benefit within a range of constraints; or continually improving; or refining; or searching for a high point or a maximum for an objective; or processing to reduce a penalty function; etc.

“Ratability” represents that the supply of one or more types of cargo is available at a steady rate over some period of time. An example of a ratability loading program for a marine transportation application would be to load the total period daily average volume (for a given crude grade of bulk material) on each day in the period. In practice, a coarser definition of ratability is often preferred, such as loading approximately one quarter of the total cargo to be loaded during each quarter of the loading period.

“Repackaging” refers to the process of unloading all or a portion of cargo into a transshipment location (e.g., the SUMED pipeline at Ain Sukhna) where the cargo can be re-loaded onto the same vehicle, or onto a different vehicle. Repackaging occurs when a configuration (e.g., volume or type) of cargo is reloaded onto a vehicle in a configuration different from the configuration unloaded from the vehicle. A non-limiting example of repackaging in the context of marine transportation is as follows. Ship1, carrying only crude oil gradeA, and Ship2, carrying only crude oil gradeB, both discharge a portion of their cargos at Ain Sukhna They then pass through the Suez Canal, and reload cargos at Sidi Kerir such that both ships now carry both crude oil gradeA and gradeB. A second example is as follows. Ship3 is carrying crude oil gradeC and ship4 is carrying cure oil gradeD. Both ships discharge (fully) at Ain Sukhna Ship5 reloads part of the cargo from Ship3 and part of the cargo from ship4 at Sidi Kerir. Ship6 is carrying crude oil gradeE, and discharges the cargo at Ain Sukhna Ship7 and Ship8 (smaller ships) reload the cargo from Ship6 at Sidi Kerir. Analogous processes may exist at other transshipment locations used for maritime shipping or other transportation points for land or air shipping. Repackaging, as used herein, would also encompass these analogous processes. This process is distinct from a drop and pick (see above) in the following way. When the same vehicle loads the same cargo that was discharged (e.g., in order to permit passage through the Suez Canal) this is a drop and pick without repackaging. However, when combinations of cargo different from those discharged from the vehicle are loaded onto the vehicle, this is referred to as repackaging. An analogous type of process may exist at other pipelines, canals, or other transshipment locations used for maritime shipping or at other special transportation locations for other shipping industries.

“Requirement” means a specification of one or more types (e.g., grade of bulk material) and associated quantities (e.g., volume) with given lower and/or upper tolerances that must be delivered during a specified time window (or any time during the planning period) to a specific segregation at a demand location. In general, the requirement could be for demand locations, or (more specifically and preferably) for a particular segregation at a demand location.

“Spot vessels” are vessels typically chartered for one voyage. In certain embodiments, the phrase “spot vessel” can also embrace any vessel with similar short term availability.

“Supply location” means a place where cargo is obtained for transportation. “Loading,” “supply,” and “origin” locations or sites (such as ports) are used interchangeably herein.

“Term vessels” are vessels chartered for a stipulated period of time. In certain embodiment, the phrase “term vessel” can also embrace any vessel with similar long term availability (e.g., fully or partially owned vessels, time charters, bareboat charters, etc.).

“Transportation scheme” represents a detailed, overall plan for transporting cargo from one or more supply locations to one or more demand locations. The scheme includes information such as timing of pickup and drop-off of cargo, amount and type of cargo to be picked-up or dropped-off, the use of special transportation locations (e.g., canals such as the Suez canal), and the assignment of vehicles to specific pickup and drop-off tasks. One goal of the present invention is to optimize these and other transportation decisions to arrive at an optimal transportation scheme.

“Type,” in the context of type of cargo, defines the nature or composition of the cargo, such as the products or material contained in the cargo. For example, in the transportation of bulk material, the type may refer to the grade of a crude oil.

“Vehicle” means any ship, barge, plane, train, truck, or any other mechanical means of transportation.

“Vessel” means any ship, barge, or other water-faring vehicle.

“Voyage” means any course of travel or passage, whether by land, sea or air, between two or more points. The terms “voyage,” “routes,” and “transportation routes” are used interchangeably herein.

### The Model's Objective, Inputs, and Outputs

A method in accordance with the present invention comprises the steps of optimizing a plurality of transportation decisions, to obtain an optimal or near optimal solution, and mechanically transporting cargo through movement of the plurality of transportation vehicles in accordance with a set of optimized transportation decisions. The plurality of transportation decisions to be optimized includes transportation routes for the plurality of transportation vehicles, allocation of cargo to be transported to one or more demand locations by the plurality of transportation vehicles within set parameters, nomination of cargo pickup from one or more supply locations by the plurality of transportation vehicles within set parameters, the use of special transportation locations, and vehicle assignments for each of the plurality of vehicles.

The optimizing step includes collecting data, using the collected data as part of a mixed integer linear programming model, and obtaining a solution to the mixed integer linear programming model to arrive at a set of optimized transportation decisions. The collecting step gathers information relating to the supply locations, the demand locations, the transportation vehicles, the cargo to be transported, various transportation information, and additional restrictions or constraints.

The mixed integer linear programming model includes an objective function and a plurality of constraints. The objective function may be for maximizing the net margin of a particular transportation scheme in a planned period. Alternatively, in certain embodiments the objective function may minimize the incurred cost for a particular transportation scheme in a planned period. Other objective functions relating to economic or financial concerns may also employed. Further, the constraints of the mixed integer linear programming model are formulated from the data collected from the collecting step.

Although the invention will herein be described in greater detail using a marine transportation example (referred to as “the marine embodiment” herein), other applications of the present invention are certainly possible such as land, air, and mixed land/air/sea transportation, for example. The use of a marine transportation example should not be interpreted to limit the scope or application of the present invention. As one of skill in the art will appreciate, the methods described herein are certainly applicable to land or air transportation problems as well.

### General Objectives of an Exemplary Embodiment

In one embodiment of the present invention (the marine embodiment), the invention is a method for the optimization of transportation decisions of a marine transportation scheme such as supply nominations, allocation of available supply, transportation routes (i.e. voyages), the use of specialized transportation locations (e.g., the Suez canal or other locations with drop and pick or repackaging capabilities), and the assignment of vehicles to various loading/unloading tasks. In certain embodiments, the method optimizes marine voyages for a plurality of marine vehicles (i.e. vessels) using a computer application. The application comprises code that, when executed, determines the optimal solution to maximize total net margin for routing, scheduling, and assignment of vehicles in an available fleet to move cargo during a planned period. Each voyage is then initiated during the planning period to transport cargo.

In this embodiment, the plurality of transportation vehicles may comprise a fleet of marine vessels. The fleet of vessels may be heterogeneous. For example, each vessel in the fleet can differ in size, shape, cargo carrying capacity, etc. More particularly, the cargo capacity of each vehicle may differ in volumetric capacity as well as weight capacity. This is true even for vehicles within the same class, such as very large crude carrier (VLCC) vessels. In addition, the fleet may differ in economic costs. For example, the fleet may comprise any combination of term vessels, owned vessels, bareboat charters, spot vessels, etc. Preferably, the fleet includes both term vessels and spot vessels. In one embodiment, each vessel in the fleet, regardless of the economic basis of its charter party, is classified as either a term vessel or spot vessel. In this instance, vessels that are available for multiple assignments (e.g., fully or partially owned vessels, time charters, bareboat charters, etc.) are typically classified as term vessels and vessels that are available for only one assignment are typically classified as spot vessels. Alternatively, the fleet may be homogenous.

Also in this embodiment, at least one of the one or more supply locations is a marine port (i.e. a supply port). Similarly, at least one of the one or more demand locations is a marine port (i.e. a demand port). Also in this embodiment, at least a portion of the cargo is bulk material, such as crude oil. The bulk material may comprise crude oil of various grades.

Each voyage definition (i.e. transportation route) specifies attributes and/or constraints that are relevant to the problem. These attributes and constraints can include, but are not limited to, the following: (1) the supply/demand locations that need to be visited; (2) the identity, type, and range of volumes of the specific cargo that needs to be loaded or discharged at each location; (3) upper and lower tolerances for the amount of cargo to be loaded or discharged at each location; (4) the permitted time window within which the loading or discharging must take place at each location; (5) the ratability of cargo made available at each supply location at various times; and (6) upper/lower bounds for the volume each type of cargo to be delivered at a specific demand location. Each voyage definition can include visits to multiple supply locations and multiple demand locations and can have a cargo that includes multiple types (e.g., different grades of crude oil). Accordingly, in one embodiment, each voyage comprises a loading segment where one or more types of cargo (e.g., three different grades of crude oil) are loaded from one or more supply locations within location specific quantity ranges and within location specific loading periods. In this embodiment, each voyage further comprises a discharging segment where one or more types of cargo are discharged at one or more demand locations within location specific quantity ranges and location specific discharging periods.

Preferably, the total cargo loaded equals the total cargo discharged in each voyage. Accordingly, in one embodiment, the total amount of each type of cargo loaded in the loading segment equals the total amount of each type of cargo discharged in the discharging segment. However, it is also possible to account for scenarios where cargo is already on a vehicle prior to a voyage or maintained on a vehicle at the end of a voyage.

Based on a set of given inputs (described below), the method arrives at a set of optimized transportation decisions. Cargo is then mechanically transported by a group of transportation vehicles based on these optimized parameters. The transportation of the cargo may be executed using any means for mechanically moving material from one location to another location. In a marine application, for example, the transportation means may include ships or other vessels. In land-based applications, the means may include trucks and other automobiles.

### Inputs to the Model

The method considers numerous input parameters and variables in determining the optimal allocation schedule, nomination schedule, transportation routes, use of specialized transportation locations, and vehicle assignments to produce the highest total net margin (or, alternatively, to minimize net incurred cost). Numerous examples of these inputs are described below. However, the examples provided herein and through this specification are not limiting. One of ordinary skill in the art will appreciate that the list exemplary inputs below is not exhaustive, and other relevant inputs in the spirit of those given herein may also be included in the present invention. Preferably, all input parameters and variables with an appreciable effect on net margin or incurred cost are considered. In addition, all variables that relate to various constraints in the mixed integer linear programming model are considered.

In a method in accordance with the present invention, the collecting step includes collecting data relating to one or more supply locations. This information can include the physical location of the supply sites, including classifying the various supply locations into regions or other geographic areas. This information may also include data on the availability of cargo (including type and amount) and the timing (i.e., window) of the availability. This information may also include any vehicle restrictions or constraints for a specific supply location. For example, a particular supply port may place limits on the draft, weight, berth, or cargo capacity of a vessel entering the port. This information may also include any port fees or other tolls associated with a supply location.

In the marine embodiment, the method's collecting step may include marine-specific supply location data, such as information or restrictions typically found in marine ports. This information may relate to the availability of a particular grade of crude oil for example. Further, this information may include parcel or cargo sizing rules or limitations. In addition, this information may include tolerances for picking up more or less than a target amount of cargo. This information may also include data associated with the ratability (i.e. the rationing out of an amount of supply cargo to vehicles over time, as opposed to a vehicle retrieving the total shipment at once).

In a method in accordance with the present invention, the collecting step includes collecting data relating to one or more demand locations. This information may include the physical location of the demand sites. This may also include factors such as the inventory and consumption schedule for cargo at a demand location, thus allowing for the determination of when more supply of cargo may be needed. The information may also include a set of requirements for a particular demand location, such as the type and amount of cargo, economic unit value of delivered cargo, delivery time window, and grouping or segregation requirements.

In the marine embodiment, the method's collecting step may include collecting marine-specific demand location data, such as information or restrictions typically found in marine ports. This information may include the make-up or blend-down ratio of various crude oil grades in a segregation. This information may also include any vehicle restrictions or constraints for a specific demand location. For example, a particular demand port may place limits on the draft, weight, berth, or cargo capacity of a vessel entering the port. This information may also include any port fees or other tolls associated with a demand location. In addition, this information may include tolerances for discharging more or less than a specified amount of cargo. In some instances, these tolerances may act as “soft” or “relative” bounds for the cargo amount. In some instances, these soft bounds may be exceeded at a cost (e.g., a certain amount of dollars per barrel of crude oil over or under the soft bounds). In addition, some demand locations may have so-called hard or absolute bounds. These tolerances, unlike the soft bounds, may not be exceeded. This information may also include information as to particular segregations required at a demand location, including current segregation inventory, segregation consumption rates or schedules, segregation blend-down ratios (e.g., blending requirements, limits, and ratios), economic unit value of delivered quantities of cargo, and the flexibility to exceed inventory limits for a cost or other penalty. This information may also relate to composition constraints for external supply or ex-ship requirements.

In certain embodiments, the data collecting step may also collect data relating to designated geographic regions. Demand and/or supply locations may be grouped into various geographic regions (e.g., Arabian Gulf, Red Sea, Japan, Europe, United States, etc.). In the marine transportation embodiment, the supply ports and/or demand ports may be grouped into certain supply and/or demand regions. Each of these regions may have a set of properties associated with it, including any of the properties mentioned herein. Additionally, these regions may have special properties, such as CSO (or LOV in the case of Japan for example).

In a method in accordance with the present invention, the collecting step further includes collecting data relating to a plurality of transportation vehicles. The data collecting step collects data from each vehicle in this group, including size, weight, cargo capacity limits, speed (both laden and ballast), starting location, and fuel consumption rates. The starting location information can be in the form of an estimated time of arrival (ETA), estimated time of departure (ETD), or last known location. The information on a vehicle's capacity limits may be expressed as a volume, weight, or any other relevant unit of measurement.

In one embodiment, the method's collecting step considers a plurality of marine vessels. In this embodiment, information is collected on the vessel capacities, bulk material densities, and the interactions between supply/demand location constraints and vehicle size, shape, speed, and fuel consumption rate. In addition, in certain embodiments where the cargo comprises different bulk materials (e.g., different grades of crude oil), these bulk materials typically have different densities that affect how much cargo can be carried. The supply and demand locations (e.g., ports) will have different physical limitations (e.g., maximum draft, maximum vessel length and width, etc.) for vehicles that use the location. The specific physical characteristics of each vehicle (e.g., draft and other parameters) determine whether a vehicle can meet the location constraints for a particular route (i.e. voyage). Also, the laden speed, ballast speed, and fuel consumption rate of each vehicle also affect net margin and incurred cost, and are collected in the collecting step. Further, cost data for both spot vessels and term vessels is considered. For spot vessels, factors such as demurrage, overage, part-cargo minimum, etc. are considered. For term vessels, factors such as fuel costs, port charges, other fees, and other penalties are considered.

If certain voyages are short enough that a vehicle can perform a sequence of consecutive voyages initiated within a given planning period (e.g., one month), then any long term vehicles (e.g., term vessels in the case of a marine application) in the fleet can be assigned to multiple sequential voyages for the planning period. Typically, the category “term vessel” will embrace any vessel that is available for multiple assignments, including time charters, fully and partially owned vessels, bareboat charters, etc. However, such multiple voyage assignments can only be made if the term vessel can meet every constraint (including temporal constraints, port constraints, etc.) for each voyage in the multiple voyage assignment. Short-term or case-by-case vehicles (e.g., spot vessels in the case of a marine transportation application) are not typically allowed to perform multiple voyages because they are usually hired on a single voyage basis. However, such consecutive voyages by spot vessels are permitted in some instances. Similarly, vehicles with charter terms that provide similar short term availability (i.e., vessels that are essentially spot vessels due to the limited nature of their charter) are not typically allowed to perform multiple voyages.

In a method in accordance with the present invention, the collecting step further includes collecting data relating to the cargo to be transported. Factors in this group of information include the type of cargo, physical properties of each cargo type (e.g., density or special handling requirements such as cargo heating), and the economic value of each cargo type.

In the marine embodiment, the method's collecting step may include collecting marine-specific supply grade data. This information may include physical properties of the crude oil, such as density and economic value for each supply grade. In one embodiment, the one or more bulk materials are liquid bulk materials. Preferably, the one or more bulk materials are one or more different grades of petroleum or petroleum derived products, such as crude oil, LNG, diesel, gasoline, etc. More preferably, the one or more bulk materials are one or more different grades of crude oil. In the case where the bulk materials are crude oils, the demand locations are typically refineries or ports that service refineries. One particular business application of this invention is the optimization of crude carriers such as VLCCs for the transportation of crude oil (or similar petroleum liquids) from source locations to refinery locations.

In a method in accordance with the present invention, the collecting step further includes collecting data relating to various transportation information. This transportation information encompasses a general category of constraints associated with moving cargo from one location to another. For example, information in this category may include distances between various locations (e.g., supply and demand locations). These distances may be expressed in length (e.g., nautical miles) or as time based on a given vehicle speed. Also, this category may encompass information about flat rate fees for transporting cargo from one location to another. This category can also include tolls (e.g., canal tolls) or other charges for Charterer or Cargo Owner account (e.g., fixed rate differentials per Worldscale, pipeline tariffs, or crude price location differentials).

In the case of the marine embodiment, the transportation information category may include information relating to drop and pick capabilities at various locations, such as canals or port locations where cargo can be both loaded and discharged. The drop and pick information may include timing, costs, cargo restrictions, or other constraints typically associated with this process. This category may also include freight costs, including world scale rates, demurrage costs, and fuel costs. Further, this category may include pipeline costs associated with drop and pick or repackaging.

A method in accordance with certain embodiments of the present invention also allows for forced assignments for any of the decision variables. For example, in certain embodiments the collecting step may collect user-imposed restrictions such as assigning a certain vehicle to certain tasks, supply locations, or demand locations and specifying supply nominations that are already fixed in the program in terms of volume and timing.

The above information, collected in the data collecting step of the present invention, is used in constructing a mixed integer linear programming model. The information above may be used to construct the objective function or the constraints of the model. In certain embodiments, information associated with costs (e.g., freight costs, tolls, fuel costs for a particular route, etc.) or revenue (e.g., economic value of certain cargo) become part of the objective function, which maximizes the total net margin or minimizes the total incurred cost. In these embodiments, the remainder of the information collected in the data collecting step is used to form the constraints of the model.

### Outputs of the Model

The method of the present invention determines an optimized set of transportation decisions that maximizes total net margin or minimizes incurred costs. Accordingly, transportation schedulers may use this method as a tool for determining optimal transportation routes, supply nominations, demand allocations, use of special transportation locations, and vehicle assignments based on a set of given data. In one embodiment, following the determination of the nomination program, the method provides the transportation scheduler with the following information: (1) the feasible vehicles for each assignment (based on timing, capacity, etc.), selected from a plurality of available vehicles; (2) a recommendation for the vehicle/voyage assignments; (3) the volume, type, and weight of the cargo to be loaded and discharged in each leg of a voyage assignment; (4) the timing for each location visit and the load and discharge events in each recommended voyage; (5) the net margin for each voyage; (6) the total net margin for the all the voyage assignments; and (7) the fleet schedule and forward position of term ships. Additional output may include estimated freight costs for each vehicle/voyage pair, inventory profiles for each supply and demand location, suggested blend-down ratios, use of drop and pick or repackaging at special transportation locations, nomination schedule (including ratability) for each vehicle/voyage pair and segregation, and allocation schedule for each vehicle/voyage pair and segregation.

In certain embodiments, the method of the present invention outputs a set of optimized transportation decisions. Decisions in this set may include the transportation routes (i.e. voyages) for a plurality of transportation vehicles (including specific times and tasks at each location and overall net margin of the voyage for a given vehicle), allocation of cargo to be transported to demand locations (including timing, type of cargo to be discharged, and tolerances), nomination of cargo pickup from supply locations (including schedule of cargo availability and tolerances), and vehicle assignments for each voyage. Other relevant information, such as economic data, names of various locations, costs associated with each location, etc. may also be output.

### Means of Executing the Model

In certain embodiments, the optimization method is in the form of a computer application that runs on a conventional computer processor (e.g., a 3 GHz single-processor personal computer). The processor may be a single standalone processor. The processor can also be a collection of interactive processors connected directly to one another or a collection of interactive processors connected indirectly to one another over a computer network (e.g., a local area network or the internet).

Certain embodiments involving the use of a computer application may also include a data entry and storage device interface. The data entry storage interface may be integral to, or interface with, the application. Data entry and storage for the application can be accomplished in a number of ways. The application can use Excel, or another type of spreadsheet software, as the data entry and storage interface. Alternatively, an ERP (Enterprise Resource Planning) system, such SAP, Oracle, and JD Edwards, or a business data warehouse (BDW), or other types of business applications can be utilized.

The application comprises code that defines calculations, simulations, and math models, and calls upon an optimization solver which is integral to, or interfaces with, the application to solve the math models. Preferably, the code is written using modeling system software such as AIMMS, GAMS, ILOG OPL, AMPL, or Xpress Mosel. However, the code could also be written using any computer programming language including C++, FORTRAN, and MATLAB. In one embodiment, the application is written using AIMMS and employs an AIMMS user interface. Preferably, the solver is capable of solving linear programming and mixed integer linear programming problems. Preferred solvers include CPLEX, Xpress, KNITRO and XA. However, other solvers known to those of skill in the art may be employed.

The outputs generated by the application in these embodiments are the optimal solution to maximize total net margin for the assignment of vehicles in an available vehicle group to a set of voyages to transport cargo from one or more supply locations having nomination requirements to one or more demand locations having various allocation requirements. The output can be exported and saved as a file using any of the data entry and storage applications discussed above (e.g., Excel, ERP, BDW, etc.).

In one embodiment, data entry and storage is accomplished using an Excel interface and the program is written in the AIMMS modeling language and calls upon a CPLEX solver to solve the math modeling problems in the program. In this embodiment, the program utilizes an AIMMS interface for execution and output. The results can then be transferred (e.g., exported or copied) back to Excel and stored as an Excel file.

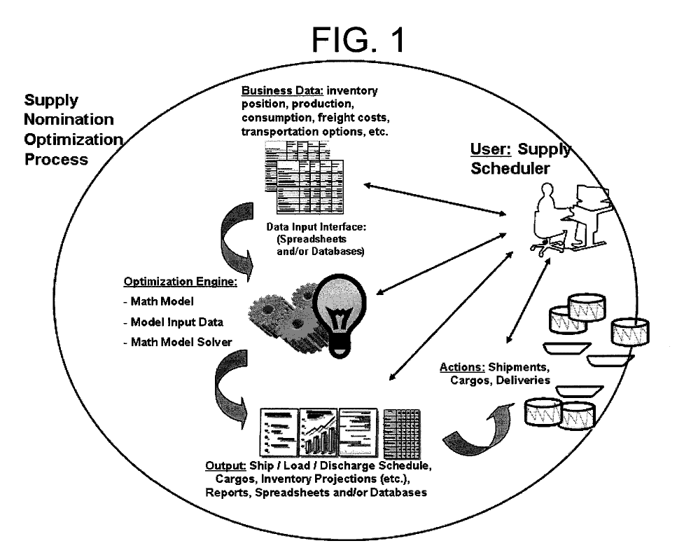

FIG. 1 illustrates a possible interaction between a user and a modeling application capable of performing a portion of the method of certain embodiments of the invention, showing various interfaces and calculation engines. A user (e.g., a Ship Scheduler) inputs Business Data including data pertaining to inventory position, production consumption, freight costs, etc. The data is input using a Data Input Interface (e.g., spreadsheets in spreadsheet program such as Microsoft Excel). The data is then exported into an Optimization Engine (i.e., the mixed integer linear programming model), which determines the optimization of a cargo loading and delivery program by determining a set of voyages for transporting cargo and assigning vehicles in an available fleet to maximize total net margin (or, in certain embodiments, to minimize total incurred cost). The results, which can then be stored, include the recommended vehicle/loading/unloading schedule, inventory projections, and other optimized transportation decisions. These results may then be displayed to a user, using spreadsheets, for example.

Accordingly, one embodiment of the invention is an apparatus capable of executing the optimization methods described herein. The apparatus comprises a processing device selected from a single processor, multiple interactive processors connected directly to one another, or multiple interactive processors connected indirectly to one another over a computer network. The apparatus also includes the computer modeling application for the optimization of marine transportation scheduling. Further, the apparatus includes a data entry and storage application that is either part of, or integrally connected to, the computer application, for inputting data comprising, but not limited to, the desired voyages, the available vehicles, and the planning period to be optimized. In addition, the apparatus includes a solver that is integral to, or interfaces with, the modeling application, capable of solving linear programming problems and mixed integer linear programming problems. Further, the apparatus includes an output and reporting application that is either part of, or integrally connected to, the computer application, for outputting the results comprising, but not limited to, vessel load and discharge schedules, inventory projections, and margins. The output can be displayed and exported in a spreadsheet or other format for use in other systems.

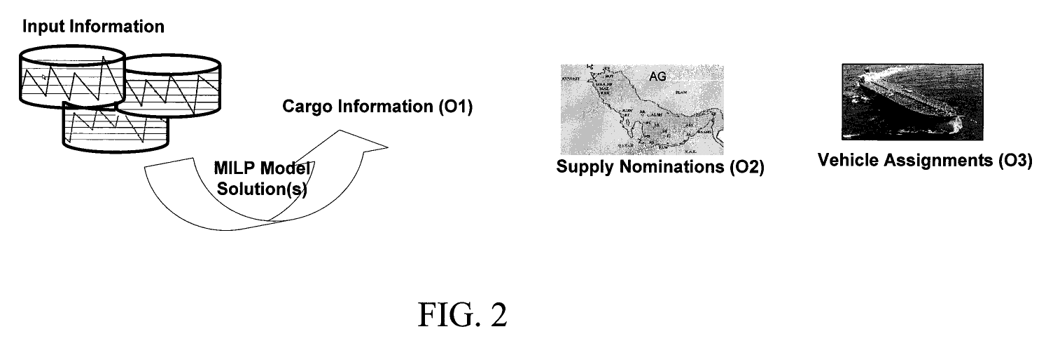

Generally, as shown in FIG. 2 for example, an apparatus in accordance with certain embodiments collects input information (e.g., location-specific data, information on available vehicles, cargo availability information, demand requirements, etc.). This information is used to form a mixed integer linear programming (MILP) model. The model is solved, yielding optimized output information O1, O2, and O3: cargo information (e.g., voyage route, cargo type and amounts), supply nominations, and vehicle assignments. These outputs may then be used to transport the cargo according to an optimized transportation scheme.

The present invention also provides an apparatus for optimizing a plurality of transportation decisions, wherein the transportation decisions include transportation routes for a plurality of transportation vehicles, allocation of cargo to be transported to one or more demand locations, and pickup of cargo from one or more supply locations. The apparatus includes a data collection application for collecting data relating to the one or more supply locations, the one or more demand locations, the plurality of transportation vehicles, the cargo to be transported, transportation information, and additional restrictions. This data collection application is also capable of providing the data to a modeling system which generates the mixed integer linear programming model. The model includes an objective function for maximizing a total net margin (or for minimizing a total incurred cost). and a plurality of constraints based on the collected data. The apparatus also includes a solver for obtaining a solution to the mixed integer linear programming mode to arrive at a set of optimized transportation decisions. The apparatus includes a user display for displaying the results of the solver to a user and the capability to export the results for use in other systems via a spreadsheet or other linkage.

### The Solution Engine

The solution engine can solve the mixed integer linear programming model as one large problem or a series of smaller component problems. In certain embodiments, to improve computation performance, the overall optimization problem may be divided into subparts. In these embodiments, various processes in a network may simultaneous work on different portions of the overall method to speed up processing time.

The solution engine can solve the model as one large problem or a series of smaller component problems. Preferably, to improve computation performance, the overall optimization problem is divided into subparts. In this embodiment, the application first determines each feasible vehicle/voyage/load-event/discharge-event combinations based on temporal and physical vehicle/voyage constraints (e.g., those in the transportation decisions listed above). The second step involves the optimal selection of voyages, assignment of vehicles to voyages, and optimal assignment of load-events and discharge-events to selected voyages-vehicle assignments as one integrated solution step so as to maximize the total net margin. It is also preferable to solve this optimization problem (or the second step described above) as at least one mixed integer linear programming portion. Two explicit choices include the solution of the optimization problem as one mixed integer linear programming portion, or to solve the optimization problem by decomposing the problem into a series of simpler sub-problems. It is also possible to modify the application by combining some or all of the subparts and mathematical programming portions.

### Voyage Generation

Supply input data and requirement (i.e. demand) input data are used to determine the complete set of load and discharge locations (e.g., supply and demand ports) that are “active” in the data set (the data for the business case being solved). This active location set, along with the location use rules (e.g., load limits, tolerances, etc.) is used to construct a set of candidate load location (i.e. supply location) rotations which have no more than a specified maximum number of load locations in each rotation. A candidate load location rotation is a sequence of one or more active load locations that satisfies the location-specific rules/restrictions, as provided in the collected constraint data for the one or more supply locations, plus the additional restriction that each load location can be visited at maximum number of times in a rotation (preferably once). A similar procedure is used to determine the candidate discharge (i.e. demand) location rotations.

Next, the potential cargo quantity, for each cargo type, in each load location rotation and each discharge location rotation are determined using the input data for supply (by load location) and demand (by discharge location) by summing the input data values based on the nominal volume and upper tolerance. In addition, a constrained cargo potential is calculated that includes the impact of location capacity limits (e.g., port draft limits, port-grade maximum cargo limits, etc.) and other load or discharge location constraints (e.g., discharge port blend-down ratios) to reduce the potential cargo quantity for load and discharge rotations (e.g., a load rotation which has a strict draft constraint at the last load port in the rotation may result in a reduced cargo potential due to this physical constraint). The result of these calculations is:

LoadRotationGradePotential(lr,c)

LoadRotationConstrGradePotential(v,lr,c)

DischargeRotationGradePotential(dr,c)

DischargeRotationConstrGradePotential(v,dr,c)

where “lr” denotes a load rotation, “dr” denotes a discharge rotation, “c” denotes a supply grade, “v” denotes a vehicle, and the calculated cargo potential represent the maximum tonnage (e.g., in kTons). Finally, potential voyages as the combination of load rotations and discharge rotations are constructed. It is assumed, for this calculation, that the cargo quantity loaded, for each type (e.g., crude grade), in a voyage must be fully discharged during the voyage, the minimum (lesser) of the potential load quantity and potential discharge quantity for each type of cargo (e.g., crude grade) in each potential voyage must be calculated. This cargo potential represents that maximum amount of cargo for each potential voyage. As before, the calculation is performed with and without the constraints (as listed above) to yield:

VoyageCargoPotential(v,voy)

VoyageConstrCargoPotential(v,voy)

to represent the maximum cargo tonnage (e.g., in kTons) for a vehicle/voyage pair. VoyageCargoPotential(v, voy) is divided by the capacity of a vehicle (e.g., vessel DWT limit i kTons or alternatively the part-cargo minimum, in kTons), to calculate the maximum fraction of vehicle capacity that can be utilized for each potential voyage/vehicle pairing.

RatioVCP(v,voy)=VoyageCargoPotential(v,voy)/VehicleCapkTon(v)

RatioVConstrCP(v,voy)=VoyageConstrCargoPotential(v,voy)/VehicleCapkTon(v)

If the fraction RatioVConstgrCP(v, voy) is greater than a user-specified minimum utilization (e.g., 0.75 or 75%), the potential voyage/vehicle pair is added to the set of candidate voyage/vehicle pairings. This procedure is repeated for each load rotation, discharge rotation, and vehicle. This results in a set of feasible voyage/vehicle pairs. For the vehicle/voyage pairs that are determined to be feasible, RatioVCP(v, voy) is used to identify voyages that have the potential to be used more than once. For example,

RatioVConstrCP(“v1”,“voyABC”)=1.1

RatioVCP(“v1”,“voyABC”)=2.3

would imply that the pair vl/voyABC is a feasible pair, and that there is sufficient cargo potential for this pair to be used twice.

For each voyage/vehicle pair in the set of feasible voyage/vehicle pairs, the feasible load and discharge activities (or events, or tasks) that can be performed are determined. In this procedure, the load and discharge locations for each voyage are considered along with supply information (nomination) and demand requirements (allocation) to identify possible matches. For example, a voyage that does not visit a particular load location cannot satisfy a load location activity for that load location. Another voyage may visit two load location (e.g., port A followed by port B), but may not be able to load the cargo at these load locations if the supply windows (given by the start and end dates in the collected data) are such that the load window for the supply at a second location (e.g., port B) ends before the load window for the supply at a first location (e.g., port A) starts. Because each candidate voyage has a defined sequence of port visits (e.g., designated by a count variable, n, where n=1, 2, 3, . . . N) and associated locations (e.g., supply ports and demand ports), the result of this procedure yields the following sets of information, which may be represented by the following arrays for example.

FeasibleVehicleVoyagelEvent(v,voy,n,p,lEvent)

FeasibleVehicleVoyagedEvent(v,voy,n,p,dEvent)

In the above, v denotes a vehicle, voy denotes a candidate voyage, n denotes the location sequence, p denotes the location (e.g., a port), lEvent denotes a load event, and dEvent denotes a discharge event. Each combination of v-voy-n-p-lEvent that is feasible will be assigned the value of 1 (one) in FeasibleVehicleVoyagelEvent(v,voy,n,p,lEvent), and each combination of v-voy-n-p-dEvent which is feasible will be assigned the value of 1 (one) in FeasibleVehicleVoyagedEvent(v,voy,n,p,dEvent). The infeasible combinations will have the default value of 0 (zero). The results of either of the above functions may be stored as a multi-dimensional array or other matrix.

### Supply Nomination Optimization Module

The above voyage generation process results in a set V of all feasible voyage options. Each particular voyage option vεV contains one particular set of voyages for all the voyage/vehicle pairs, its location sequence, locations (e.g., ports), and load events/discharge events. A mixed-integer linear programming model is then used to optimize within this set V of all feasible voyage options to select the particular voyage option v that results in the greatest net profit margin. As such, the mixed integer linear programming model comprises an objective function that has as its terms, the total revenue generated minus the cost incurred for each vεV. The solution to the linear programming model provides a supply nomination schedule, allocation schedule, and shipping routes (i.e. voyages) that maximizes the total net margin.

The net margin for each of the particular set of voyage options vεV can be presented as NMᵥ=REVᵥ−ICᵥ, where NMᵥ represents the net margin for a voyage option vεV, REV_{V} is the total revenue generated by all the voyages in voyage option set v, and ICᵥ is the total costs incurred by all of the voyages in voyage option set v. The model is then solved for the particular voyage option v providing the maximum net profit margin.

In this particular embodiment, the objective function has decision variables for each of the three arrays FEAS_SV (which defines the vehicle/voyage pairs), FeasibleVehicleVoyagelEvent, and FeasibleVehicleVoyagedEvent. The solution to the linear programming model will contain the selected vehicle/voyage pairs from within FEAS_SV, and to these vehicle/voyage pairings, it will select the load and discharge events that are serviced within each voyage/ship pair.

### Voyage Freight Cost

Because each voyage has now been pre-generated with a known sequence of location visits, the flat rate for each voyage may be calculated (as in U.S. patent application Ser. No. 12/285,651, entitled “System for Optimizing Transportation Scheduling,” the entirety of which is incorporated by reference herein above). The baseline cost for a voyage is the product of flat rate, 0.01, the Worldscale rate (expressed as a percentage), and part-cargo minimums. These values are all given or known. The additional freight costs (e.g., overage and demurrage) will be calculated during the optimization step, because these depend upon the outcome of decision variables (e.g., the schedule of vehicles, quantities of cargo loaded and discharged, etc.).

### Use of Generated Voyages Within the Optimization Model

FEAS_SV, FeasibleVehicleVoyagelEvent, and FeasibleVehicleVoyagedEvent (collectively referred to as the “feasibility arrays”) define the space of feasible voyages, and feasible utilization of voyages (e.g., load and discharge activities that can be performed by a particular vehicle/voyage pair). The optimization model contains binary decision variables that take the value of 0 or 1 to denote a no or a yes decision for the feasible options defined by FEAS_SV, FeasibleVehicleVoyagelEvent, and FeasibleVehicleVoyagedEvent. In other words, the voyage generation step defines the set of possible actions, and the mixed integer linear program optimizes within this set of possible actions. Because, in general, the number of possible combinations of supply locations and demand locations can be very large, the number of possible voyages generated can also be very large. In order for the method in this invention to be effective (i.e. usable, viable, practical), the procedure used to determine FEAS_SV, FeasibleVehicleVoyagelEvent, and FeasibleVehicleVoyagedEvent serves a critical role to generate only the minimum number of feasible combinations. However, the procedure must also simultaneously be comprehensive and include all the options that are needed to generate an optimal nomination plan.

### Terms in the Objective Function

In certain embodiments, the mixed integer linear programming model considers each of the constraints described above to produce a nomination schedule, an allocation schedule, and shipping routes (i.e. voyages) that maximizes the total net margin. In these embodiments, the total net margin becomes the objection function. The total net margin may be expressed, in its simplest form, as the sum of the net margins for each vehicle/voyage pair in a transportation scheme. For example, the total net margin may be represented by

NM=Rev—IC=ΣiNM=EiRev−ΣiIC (Eq. 1)

where “NM” represents the total net margin for a transportation scheme, “Rev” represents the total revenue for a transportation scheme, “IC” represents the total incurred costs for a transportation scheme, “ΣiNM” represents the sum of each net margin for a each individual vehicle/voyage pair in the transportation scheme, “ΣiRev” is the sum each revenue earned by each individual vehicle/voyage pair in the transportation scheme, and ΣiIC is the sum of each of the costs incurred by each vehicle/voyage pair in the transportation scheme.

The individual net margins may be expressed, simply, as the revenue for the vehicle/voyage pair minus the incurred cost of the vehicle/voyage pair, as shown also in Eq. 1. The incurred costs may include freight costs (e.g., spot vessel costs and term vessel voyage costs), inventory soft bound costs, and inventory hold costs.

Revenue may be determined as follows. Each selected voyage-vehicle pair (voyage-vehicle pairs that are not selected must not transport any cargo) will have an associate quantity of cargo that is loaded and discharge. Thus, for each demand location and segregation pair, revenue may be calculated based on the amount of cargo discharged at the demand location/segregation pair, and the unit value of the discharged cargo. For example, revenue for each type of cargo at each demand location/segregation pair may be expressed by

IndRevenue_{T,DL,SEG}=unit value of cargo*discharge amount (Eq. 2)

where “IndRevenue_{T,DL,SEG}” is the revenue for a given type of cargo (T) at a particular location (DL) and (SEG) is a particular segregation, “value of cargo” is the economic unit value of the particular cargo type (which may be expressed as unit currency per volume, unit currency per mass, or unit currency per unit, such as US$/barrel of crude oil for example), and “discharge amount” is the quantity of cargo of type “type” discharged into segregation “SEG” at location “DL.” The discharge amount may be expressed in volume, mass, or units. Preferably, the “discharge amount” unit corresponds to the “value of cargo” unit.

The revenue for each type of cargo at each demand location is summed over all cargo types, T, and all suitable segregations, SEG, at all demand locations, DL, in the transportation scheme. This sum equates to the total net revenue for the transportation scheme.

As stated above, the incurred cost may include freights costs, inventory soft bounds, and inventory hold costs. Preferably, a mixed integer linear programming model in accordance with the present invention includes at least the freight costs and the inventory soft bounds costs in its objective function. However, additional costs may be considered as well.

The freight costs may vary depending on whether a short-term vehicle (e.g., a spot vessel) or a long-term vehicle (e.g., a term or charter vessel) is used. Freight costs for a short-term vehicle will now be described using the example of a spot vessel. Notwithstanding this example, however, it should be understood that a similar process may be used for other types of transportation vehicles.

In the context of a spot vessel, the freight cost may be a function of part-cargo minimums, overage rates, demurrage rates, or other vessel particulars such as capacity, deadweight limit, etc. Using these considerations, a freight cost for a single spot vessel may be expressed by

FCostS_{SV,VOY}=FR*WSRate*(PCMin+OTonnage*ORate*0.01)*0.01+DRate*DDays (Eq. 3)

where “FCostS_{SV,L}” is the freight cost for a particular spot vessel (SV) to to perform a voyage (VOY), “FR” is the voyage flat rate (i.e., Worldscale100 rate for the voyage) and is typically in U.S. dollars per ton, WSRate is the market Worldscale rate expressed as a percentage, “PCMin” is the part-cargo minimum (typically expressed in kilotons), “ORate” is the overage rate expressed as a percentage of the WSRate, “OTonnage” is the tons of cargo above the PCMin, “DRate” is demurrage rate (typically expressed in thousands of U.S. dollars per day), and “DDays” is the number of days in excess of allowed lay time for which demurrage charges are being assessed.

In the context of a term vessel, the freight cost may be a function of bunker fuel consumption rates (while idling, ballast, and laden), net hire values, bunker fuel costs, port fees, or other ship or port parameters such as vessel capacity, deadweight costs, or tolls. Using these considerations, a freight cost for a single term vessel during a given voyage or a sequence of voyages may be expressed by

FCostT_{TV,VOY}=fuel consumed*fuel cost+fees+tolls+nethirevalue*NHdays (Eq. 4)

where “FCostT_{TV,VOY}” denotes the freight cost for a particular term vessel (TV) to perform a particular voyage (VOY), “fuel consumed” represents the amount of fuel consumed by the term vessel usually expressed in metric tons (this is turn may be a function of the distance traveled, fuel consumption rate, and other relevant factors), “fuel cost” represents the unit cost of fuel used by the vessel usually expressed in $ per metric ton, “fees” includes any fees charged by the demand location such as port fees, “tolls” denotes any tolls required during the vessel's voyage such as canal tolls, “nethirevalue” represents the net hire value (see below) for the term vehicle, and “NHdays” denotes the number of days the term vehicle is idle.

The net hire value mentioned above may be derived from a daily rate that a term vehicle is assumed (or expected) to earn when assigned to a typical voyage in a particular trade route. The net hire value can be used to represent a lost opportunity during time when the vehicle is idle. In addition, there can be addition fuel consumption during idle time for a term vehicle and the associated cost can be added to the net hire value. Analogous to the estimated spot vehicle demurrage cost for demurrage time, one can calculate a cost for term vehicle idle time as shown in Eq. 5 below. This consideration may be accounted for in the objective function (e.g., the equation for determining net margin), for example by including the following formula in the incurred cost term or by incorporating a similar term into Eq. 4 (as shown above). In other embodiments, the model does not account for the net hire value.

FCostTIdle_{TV,VOY}=idle_time*(net hire value+idle_fuel_consumption_cost) (Eq. 5)

In Eq. 5, “FCostTIdle_{TV,VOY}” represents the idle time cost for each term vehicle (TV) to perform voyage (VOY), “idle_time” denotes the amount of time a particular term vehicle is idle (expressed in hours or days for example), “net_hire_value” denotes the value of the vehicle per some unit time, and “idle_fuel_consumption cost” denotes the idle fuel consumption cost per some unit time for the particular term vehicle.

A freight cost for each spot vessel in the set of feasible vehicle/voyage pairs may be calculated using Eq. 3 and summed over all spot vessels, SV, and all voyages, VOY, to arrive at a total spot vessel freight cost. Similarly, a freight cost for each term vessel in the set of feasible vehicle/voyage pairs may be calculated using Eq. 4 and summed over all term vessels, TV, and all voyages, VOY, to arrive at a total term vessel freight cost. The total spot vessel freight cost and the total term vessel freight cost may then be summed together to arrive at a total freight cost. The total freight cost, in turn, may be used as a term in the incurred cost term of the objective function.

The inventory soft bound costs may be determined as follows. A receiving location (e.g., a demand port), may have segregation inventory limit that have both soft and hard bounds. The soft bounds may be exceeded for a price, so long as the cargo discharged remains within the inventory hard bounds for a given segregation. Accordingly, these costs may be an important factor in the incurred cost term of the objective function. Inventory soft bound costs may be expressed as a function of the cost to exceed the soft bounds, the amount of cargo provided in excess of these bounds, and the soft bounds themselves (i.e., base inventory minimums and maximums). Using these considerations, an inventory soft bound cost for a particular vehicle at a particular demand location may be expressed by

ISBCost_{DL SEG}=excess cargo*cost to exceed (Eq. 6)

where “ISBCost_{DL SEG}” represents the inventory soft bound cost for a particular segregation at a particular demand location (DL), “excess cargo” represents the amount of cargo in excess of the minimum or maximum inventory bounds for a particular location (which may in turn be a function of the amount of cargo discharged and the soft bounds of the particular location), and “cost to exceed” is the cost associated per unit cargo exceeding the soft bounds (which may be given in U.S. dollars per unit cargo, for example).

The inventory soft bounds cost may be summed over all demand locations, DL, and segregations, SEG, in the transportation scheme. This sum equates to the total inventory soft bound costs for the transportation scheme, which may in turn included in the incurred cost term of the objective function.

The inventory hold costs may be determined as the product of the average inventory level multiplied by the holding cost (which may be given in U.S. dollars per unit cargo, for example). This may be expressed as the following equation, for example.

IHCCost_{DL,SEG}=average inventory*holding cost (Eq. 7)

The inventory hold cost may be summed over all demand locations, DL, and segregations, SEG, in the transportation scheme. This sum equates to the total inventory hold costs for the transportation scheme, which may in turn included in the incurred cost term of the objective function.

Each of the cost terms described above (represented by Eqs. 3-7) may be summed to arrive at the total incurred cost (IC) for a particular transportation scheme. In other words, the total freight cost (for both spot and term vehicles), the total inventory soft bounds cost, and the total inventory hold cost may be added together to arrive at the total incurred cost. Certain embodiments may exclude one or more of these terms, and other embodiments may include additional terms (such as the cost of in transit working capital, cargo or vessel insurance costs, and oil loss costs). Preferably, the incurred cost includes at least the total freight cost and the total inventory soft bounds cost.

The total incurred cost is subtracted from the total revenue (as shown in Eq. 1) to arrive at the total net margin. In certain embodiments, the total net margin is used as the objective function, and the objective function accounts for both revenue and incurred costs. Accordingly, the constraints and inputs described here become the constraints and decision variables of the mixed integer linear programming model. In other embodiments, the objective function minimizes the total incurred cost, and revenue is not a factor in the objective function.

It can be seen that the maximization of total net margin will result in the simultaneous: (a) reduction/minimization of dead-freight due to the revenue term, (b) reduction/minimization of idle time for vehicles, (c) maximize the efficiency of the transportation program by selecting preferred voyages (e.g., based on voyage flatrates and/or voyage costs), (d) reduction/minimization of voyage costs such as bunker fuel costs (and other fees and charges), (e) maximize the utilization of term and spot vehicles based on the comparative freight costs, (f) maximize the utilization of vehicle class options by considering the corresponding freight costs, (g) maximize the allocation of available supply to allowed demand locations and corresponding segregations (as appropriate), and (h) reduction/minimization of inventory costs incurred when exceeding soft bounds and/or when holding costs are incurred.

Note that each individual net margin for each feasible vehicle/voyage pair is a calculated prediction, largely because the incurred cost, which may not be known for certain until a vehicle has actually completed a voyage, must be predicted.

With respect to feasible multiple vehicle/voyage assignments, all the concepts described previously remain valid and the concept of net margin is still applicable. The fuel consumption is calculated based on the laden portion of each voyage plus the in-port during each voyage, plus the ballast and any idle portions ahead of the first laden voyage and between consecutive voyages, plus the ballast and any idle portions (to return to a reference location in the principle load region) after the last laden voyage performed. Other cost and revenue terms are additive when applied to a multiple voyage combination. Additionally, the mixed integer linear programming model may include constraints to ensure that each term vehicle is permitted to do no more than one voyage combination (where a combination can consist of one or more consecutive voyages).

### One Solution Procedure

One approach is to directly solve the model using a general purpose mixed integer linear programming solver. A suitable mixed integer linear programming optimization routine using CPLEX, Xpress, XA, KNITRO or another MILP solver can be used to solve the mixed integer linear programming problem.

### Preferred Solution Procedure

Although the pre-processing is effective at generating an efficiently balanced set of solutions (i.e. it eliminates certain unnecessary voyage options that may otherwise cause the problem size to be prohibitively large), a direct solution of the model with a general purpose mixed integer linear programming solver may not produce a solution in an acceptable amount of processing time. For such instances, in certain applications of the method of the present invention, it may be desirable to temporarily simplify the model during certain steps in the solution process in order to achieve more favorable processing times while still preserving the effectiveness of the optimization. Thus, the following solution methods using simplified models have been developed. Each of these solutions may be used independently as the complete model (i.e., the results of the model become the basis for transporting cargo), or they may build upon each other as described below (i.e., step 3 imports the results from step 2, etc.).

Step 1: A selected complicating feature of the problem is simplified to yield a model that is easier to optimize (to solve), and this model is solved. Preferable, the solution yields an approximate solution to the original model, and upper (lower) bound target for the maximize (minimize) net margin (cost) objective function. One such simplified version of the model is a version in which the demand location inventory constraints are ignored. (Note that, in certain other embodiments, other assumptions may be made or other constraints may be removed such that the overall model is simplified.) Because this can be a much simpler model, it can be solved (using a general purpose mixed integer linear program solver with either default or custom solver settings) in much less time than the original, “full” model. Also, because the results of this model need not satisfy the inventory limits, the objective function value becomes an overly optimistic result and provides an upper limit (or high target) for the objective function value of the full model. In other words, the results of this simplified model may represent a “best case” scenario. The solution from this step also includes a set of selected vehicle/voyage pairs (a subset of vehicle/voyages assignments from within the set FEAS_SV, for example). For convenience, the objective function value obtained in step 1 will be referred to as OBJ_{—}1.

Step 2: In step 2, the original model (with inventory limits) is solved, but the feasible set of voyages is reduced (e.g., temporarily restricted) to be a subset of the full set FEAS_SV. The reduced set (RED_FEAS_SV) can be defined to include only the optimal voyages derived from step 1 (for example, let RED_FEAS_SV(v, voy)=FEAS_SV(v, voy) for each voyage that was selected in the solution to Step 1). This greatly reduces the problem in terms of size but accounts for complicating factor that was simplified (or ignored) in step 1 (for example, the demand port inventory constraints). This problem may be solved directly with a general purpose mixed integer linear programming solver using either default or custom solver settings. Because this problem does not include the full set of feasible vehicle/voyage options, the solution obtained here may not be the optimal solution to the original problem. However, this solution still provides a feasible transportation scheme because it satisfies all the constraints of the original model. The objective function value provides a lower bound on the objective function value for the original problem (i.e., it may be possible to obtain a more optimal solution when the full set of feasible vehicle/voyage options are considered). This step is referred to as a “Construction Heuristic” because it constructs a feasible solution to the original problem. It may in fact be the optimal solution to the original problem, but this is not guaranteed. Let OBJ_{—}2 be the objective function value obtained in step 2, and let DeltaOBJ_{—}1-2 be the difference between the objective function values from step 1 and step 2 (i.e., DeltaOBJ_{—}1-2=OBJ_{—}1−OBJ_{—}2). If ABS(DeltaOBJ_{—}1-2) (where ABS( ) denotes the absolute value) is acceptably small, then an acceptable solution to the problem has been found. In this case, the method may skip to step 6.

Step 3: The original FEAS_SV array is restored as the full set of feasible options. The solution from step 2 is provided as a starting point (or initial solution) for the solution procedure in step 3. This problem is solved using a general purpose mixed integer linear programming solver. This may be achieved by using a particular method in CPLEX called Solution Polishing for a specified period of time. Alternatively, the problem may be solved using the default method in CPLEX for a specified period of time. The result from step 3 is potentially an improvement over the solution of step 2 (however it is guaranteed to be no worse than the solution to step 2). Accordingly, this step is referred to as an Improvement Heuristic step. Depending on the time limit provided and the degree of difficulty in the mixed integer linear programming model, the solver may converge to a proven optimal solution before reaching the time limit. If so, step 4 is not required. Let OBJ_{—}3 be the objective function value obtained in step 3, and DeltaOBJ_{—}1-3 is difference between the objective function values from step 1 and step 3 (i.e., DeltaOBJ_{—}1-3=OBJ_{—}1−OBJ_{—}3). If ABS(DeltaOBJ_{—}1-3) is acceptably small, then an acceptable solution to the problem has been found. In this case, the method may skip to step 6.

Step 4: A solution-space reduction heuristic is applied. For example, the following condition may be applied: no more than a user-specified number of the voyages (e.g., two) used in the solution from step 3 may be changed. This is a heuristic approach in that it is assumes that some portion of the solution from step 3 is optimal and that the solver must keep these decisions fixed and only allowed change to a subset of the voyage decisions. This is achieved by adding a constraint which limits the number of vehicle/voyage pairs that can be changed from a value equal to zero to a value equal to one (i.e., the associated binary variable for the selection of a voyage and associated vehicle assignment) in the mixed integer linear programming model. The added constraint of this step makes it is more probable that a mixed integer linear programming solver will converge to a proven optimal solution within an acceptable amount of time. Let OBJ_{—}4 be the objective function value obtained in step 4, and DeltaOBJ_{—}1-4 is difference between the objective function values from step 1 and step 4 (i.e., DeltaOBJ_{—}1-4=OBJ_{—}1-OBJ_{—}4). If ABS(DeltaOBJ_{—}1-4) is acceptably small, then an acceptable solution to the problem has been found. In this case, the method may skip to step 6. If the allowed time limit for step 4 has been exceeded, skip to step 6. Otherwise, calculate DeltaOBJ_{—}4-3 as the difference between the objective function values from step 4 and step 3 (i.e., DeltaOBJ_{—}4-3=OBJ_{—}4−OBJ_{—}3).

Step 5: This is an optional step which can be taken (multiple times) if the result from step 4 is indeed an improvement over the result from step 3. If DeltaOBJ_{—}4-3 is greater than a specified amount, then the solution-space reduction is updated to reflect the current best solution obtained in step 4, and steps 4 and 5 are repeated until the time limit is reached, or when the difference between objective function values from successive solutions of step 4 is less than the specified amount.

Step 6: Given an optimal or near-optimal solution, the mathematical model solution is translated into a supply nomination program and corresponding loading and discharging schedule, which becomes the recommended actions to be taken. The output (i.e. results of the objective function) from any of steps 1-5 (but preferably the output from steps 2-5) may be selected by a user as an optimized transportation scheme. Thus, for example, if a user determines that the output from step 3 is acceptable, the user may stop the custom method at that point and use the results from step 3 as the transportation scheme.

An exemplary solution will now be described for a non-limiting embodiment of the custom solution method described above with reference to Tables 1 and 2. First, the model removes all the demand port segregation inventory constraints in accordance with step 1 above. Then, the model is solved to mazimize the total net margin. As shown in Table 1 below, the value for this net margin is $492,000. Next, the vehicle/voyage assignments made in the solution in step 1 (e.g., the vehicle/voyage pairs in the RED_FEAS_SV array are restricted to include voyages 15, 22, 55, and 143) are used to define as the possible vehicle/voyage assignments for a new model, as in step 2. This second model, however, does account for the demand port segregation inventory constraints. This model is solved, yielding a second value for the total net margin (in this case, −$603,000 as shown in Table 1). Next, the difference between the total net margin for step 1 (OBJ_{—}1) and the total net margin for step 2 (OBJ_{—}2) is determined. If the absolute value of this difference is small (i.e. within a certain tolerance), then the solution is considered acceptable and no further models are run. However, if the difference is not sufficiently small (as in the example in Table 1), the method proceeds to step 3. In this step, the original full array of possible vehicle/voyage assignments is restored, but the output from step 2 is used as an initial condition or starting point. This new model is solved, yielding a third total net margin (OBJ_{—}3). This new value is compared to the value for total net margin in step 1, and if the absolute value of this difference is sufficiently small, the method terminates and no further models are run. However, if the difference is not sufficiently small, the model proceeds to step 4. In this step a solution-space heuristic is applied to the model, and this new model is solved once again. The solution yields a fourth total net margin (OBJ_{—}4), which is compared to the third total net margin (OBJ_{—}3) or the first total net margin (OBJ_{—}1. If the difference between these values is small, then the method terminates and no further models are solved. However, if the difference is not sufficiently small, step 4 may be repeated as necessary. In this example, there is no difference between the fourth total net margin and the third total net margin. Thus, the fourth step did not help to reach an improved solution. But, the optimizer was successful in converging the model of step 4 in a reasonable period of time. In this case, the method may terminate, and the solutions to step 4 may be used as the solution for the problem

TABLE 1

| Step | Value of Obj. Function | Difference Used | Difference Value |
|---|---|---|---|
| Step 1 | $492,800 | n/a | n/a |
| Step 2 | −$603,000 | OBJ_2 − OBJ_1 | −$1,096,000 |
| Step 3 | $376,350 | OBJ_3 − OBJ_1 | −$116,000 |
| Step 4 | $376,350 | OBJ_4 − OBJ_1 | −$116,00 |
| | | OBJ_4 − OBJ_3 | $0 |

Note also that the vehicle/voyage assignments may change for each step. For example, Table 2 shows the vehicle/voyage assignments for each of the steps in the example above. Table 2 shows the voyage each vehicle will optimally undergo for each step of the custom solution described above. Each voyage will contain information on the various locations a vehicle will visit and may also include supply nomination and/or demand allocation schedule information as well.

TABLE 2

| Step | Vehicle A | Vehicle B | Vehicle C | Vehicle D |
|---|---|---|---|---|
| Step 1 | Voyage_15 | Voyage_22 | Voyage_55 | Voyage_143 |
| Step 2 | Voyage_15 | Voyage_22 | Voyage_55 | Voyage_143 |
| Step 3 | Voyage_15 | Voyage_55 | Voyage_71 | Voyage_155 |
| Step 4 | Voyage_15 | Voyage_55 | Voyage_71 | Voyage_155 |

### Additional Features of the Method

In certain embodiments, the method may comprise additional features. For example, the model may allow for certain user-defined constraints or restrictions. These user-defined constraints include, but are not limited to, rules that limit the allowable supply location sequences, rules that impose a maximum number of supply and/or demand ports in a given voyage, and limits on the total number of times that each load location may be visited on any given voyage or in the entire loading program.

Additionally, in certain embodiments where portions of the method are executed using a computer application, the application may contain validation checks throughout. These validation checks allow a user to view and approve certain output of the application at various points in the process. The user may also have the option to cancel or break the process at certain points if the output seems unreasonable or impractical or is otherwise unacceptable. The user would then have the option to return to other points in the process to reenter certain input information and/or change other constraints or restrictions. Alternatively, the application itself could include checks at various points in the process to ensure that there are no errors in the output data. If the application determines that an error has occurred, it may give the user an option to rerun the application or to alter the model's input or other constraints. In general, it is desirable to identify inconsistent input data and to warn the user about potential data input errors as early as possible.

Further, in certain embodiments the method includes case management capabilities. In certain embodiments where a portion of the method is carried out using a computer application, the computer application may for example have the ability to save, organize, and stores various output. Additionally, these embodiments may allow a user to reload the output at later times or to have certain input “templates” for use with various models. In certain embodiments, the method allows certain input parameters to be changed and the resulting output to be compared to the results prior to those changes.

Additionally, the present invention may also include components for tracking inventory during a transportation scheme. Such components may include, for example, the use of a global position system (GPS) to track cargo or vehicles as they move from location to location.

Certainly, other features known to those of skill in the art that would aid in the optimizing of a transportation scheme and the mechanical transporting of cargo in accordance with the optimized scheme may be applied to the present invention. The examples provided herein in no way limit the potential for such application.

### A Work Process Using the Model

One embodiment of the invention is a work process for marine transportation scheduling that uses the method previously described to optimize various transportation decisions and mechanically transport cargo in accordance with the set of optimized transportation decisions. In one embodiment, a collecting data step of the method comprises inputting and/or modeling options into a database system. The database system is integral to, or interfaces with, the modeling application for marine transportation scheduling. In this embodiment, another step is to run the application to solve the mathematical model after the data and/or modeling options are input using an optimization problem solver to obtain a set of optimized transportation decisions. In certain embodiments, an additional (optional) step may be to repeat the preceding steps one or more times with different data and/or constraints to obtain one or more alternative sets of optimized transportation decisions. In certain embodiments, a final step is to mechanically transport cargo in accordance with the optimized set of transportation decisions.

The application is typically executed multiple times to explore sensitivities in input data, different assumptions, and different assignment constraints (e.g., force the model to assign a given vessel to a given voyage and optimize the rest). The application runs fast enough to support these sorts of what-if scenarios. In one embodiment, the application performs the calculations for a typical problem in approximately 30-45 minutes, running on an unimpeded 3 GHz dual-core personal computer.

Typically, the supply nomination planning cycle is monthly and considers a one-month loading period. The voyages, including cargo to be transported, and the available fleet may and probably will vary from cycle to cycle. Also, the economic factors including freight costs, fuel costs, etc., will change daily on both a regional and worldwide basis. During the planning cycle, decisions are made and updated frequently based on the current problem characteristics and considerations.

A non-limiting example of a work process according to certain embodiments of the present invention is as follows. First, the optimization model is run at the start of the business cycle. The supply nomination decisions have the maximum degree of flexibility. The solution(s) obtained provide recommended actions to be used to nominate a supply schedule. Second, suppliers review, accept, and/or counter various portions of the nominated supply program, eventually arriving at a confirmed supply schedule and corresponding load quantities. Third, the process is repeated as additional supply nominations are confirmed, and the optimization model re-optimizes the entire nomination program accordingly. Finally, all the supply nominations are confirmed, and the transportation program and vessel assignments to requirements may still be optimized to maximize the total net margin. In addition, the discharge location input data (projected initial inventory level, processing rates, location and/or segregation requirements, and other problem data) may continue to change and thus encourage a user to continue to optimize the nomination/transportation program.

### Beyond Marine Transportation

Although the invention has been described in the context of marine transportation, which is the preferred embodiment, it is equally applicable for use in the optimization of any mode of cargo transportation. Virtually all of the teachings described above with respect to marine transportation are easily adapted to create similar applications for the optimization of transportation using any other type of fleet—regardless of whether the fleet is a collection of trains, trucks, planes, or other form of cargo transportation. In addition, the teachings can be employed with any combination of trains, trucks, planes, vessels, or other forms of mechanical transportation.

For example, the concept of optimizing a land transportation scheduling problem (e.g., by truck) is similar to optimizing a marine transportation problem. In both problems, the vehicles in the fleet may vary in size, speed, and load capacity. Furthermore, in both problems, the vehicles in the fleet may be different charter types (e.g., term or spot or fully owned). Also, in both problems, there is the need pick-up at each supply and deliver to each demand location specific amounts of cargo within location-specific time frames. Illustrative physical restrictions that might limit the physical ability for any given truck in the fleet to perform a voyage include any applicable federal, state and county regulatory limitations on truck weight (as measured at mandatory weight stations), truck size, and number of trailers. Illustrative temporal restrictions that might limit the ability for any given truck in the fleet to perform a voyage would include the location and time of first availability in view of voyage start time and relevant maximum highway speeds. Port restrictions in the marine transportation problem can be replaced in a land transportation problem with state operator licenses.

Similar examples exist in the airline and railway industries. Accordingly, a more general embodiment of the invention may be a method for the optimization of transportation scheduling that calculates the optimal solution to maximize total net margin for the assignment of vehicles in an available fleet of transportation vehicles to perform a set of voyages to be initiated during a planning period for transporting cargo comprising various types of products. Preferably, the total net margin is derived from the individual net margins for each vehicle/voyage assignment and, more preferably, the total net margin is the sum of the individual net margins for each vehicle/voyage assignment. Again, each individual net margin for a transportation vehicle/voyage assignment is derived from the market value for the voyage using a notional vehicle and a predicted incurred cost for the voyage using the assigned vehicle.

In these additional applications, the vehicle fleet can be heterogeneous. For example, each vehicle in the fleet can differ in size, shape, cargo carrying capacity, etc. In addition, the vehicle fleet may differ in economic costs (e.g., contract terms). For example, the fleet may comprise any combination of term vehicles, owned vehicles, spot vehicles, etc. Preferably, the fleet comprises both term vehicles and spot vehicles. In one preferred embodiment, each vehicle in the fleet, regardless of the economic basis of its contract, is classified as either a term vehicle or spot vehicle.

### Illustrative Example

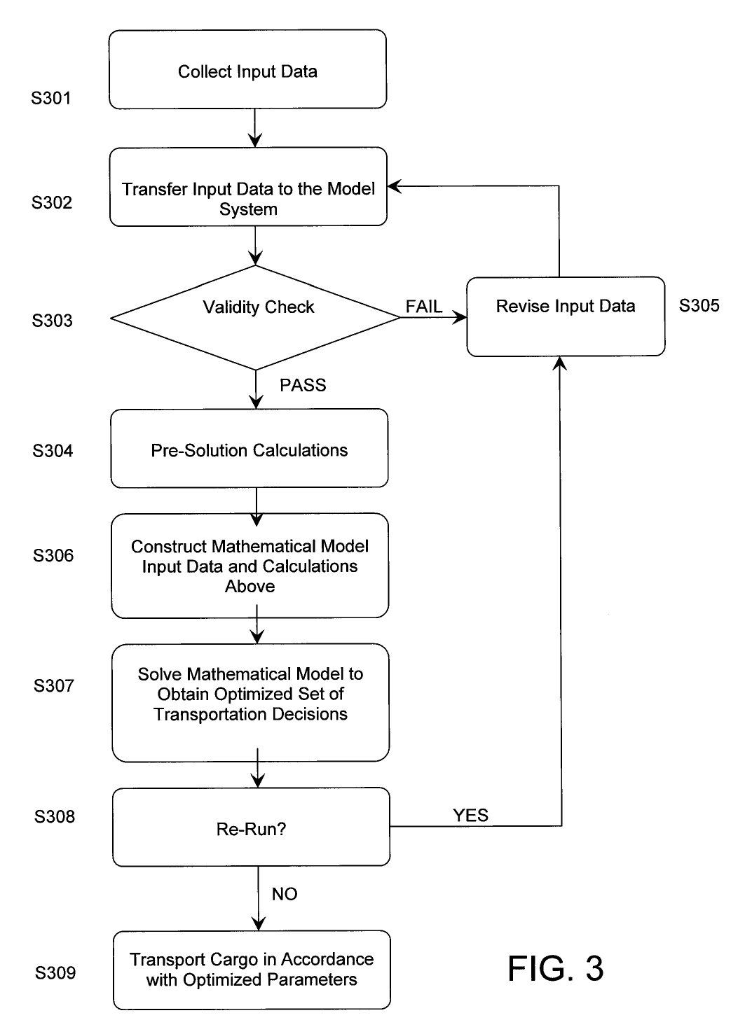

Generally, a method in accordance with certain embodiments of the present invention is carried out in accordance with the steps in FIG. 3.

A non-limiting example of one embodiment of a method in accordance with the present invention will now be described. First, in step S301, input data is collected. This input data may be any of the information or constraints described above, including location-specific information, supply availability, demand requirements, and vehicle availability. Next, in step S302, the collected input data is transferred to a mathematical model (preferably a mixed integer linear programming model). At this point, in step S303, a data validity check may be conducted (either by the user or by a computer application) to ensure that the input data has imported properly, that no crucial input data has been omitted, or that some error has not occurred. If this validity check passes, then the method proceeds to the construction of feasibility arrays in step S304. If the check fails, however, the method proceeds to step S305, where a user may revise input data or other constraints. After the revision in step S305, the new input data is then fed into the model (i.e., the method returns to step S302). Once the data validity check is passed, the method proceeds to step S304. Here, the feasibility arrays are constructed, such as arrays FEAS_SV, FeasibleVehicleVoyagelEvent, and FeasibleVehicleVoyagedEvent as described above. In step S306, the mathematical model (preferably a mixed integer linear programming model) is constructed using the collected data. In this step, in certain embodiments, both the objective functions and the constraints may be formed. In step S307, the model is solved (using, for example, a mixed integer linear programming solver with either default or custom solver settings). The results of this model are then observed in step S308. Also in step S308, a user determines whether the model should be re-run for any reason. For example, a user may wish to re-run the model if the results (i.e. a set of optimized transportation decisions) are not acceptable or do not seem practical. Also, a user may wish to re-run the model in order to compare the effects of various input data on the results of the optimization, or to otherwise compare various results. If the user wishes to re-run the method, then the user may revise various aspects of the model (such as input parameters and other constraints) in step S305 to arrive at a revised mathematical model. Steps S302-S308 may then be repeated until the user no longer wishes to run additional models (e.g., an acceptable set of optimized transportation decisions has been determined). After having run the model one or more times, the user selects a set of optimized transportation decisions from the one or more results and uses this solution to form a transportation scheme. Cargo is then mechanically transported (e.g., via marine vessels, trucks, planes, or some combination thereof) according to this scheme in step S309.

In certain embodiments, two or more mixed integer linear programming models are solved, each of the models having different constraints, input data, or other restrictions. A user may compare each of the solutions obtained for each of these models and decide on an optimal transportation scheme based on this comparison. The user may select one of the solutions or a combination of a portion of two or more of the solutions. The cargo would then be mechanically transported in accordance with the selected transportation scheme.

### CLOSING

While various embodiments have been described, other embodiments are plausible. It should be understood that the foregoing descriptions of various examples of a method of transporting cargo through an optimized transportation scheme are not intended to be limiting, and any number of modifications, combinations, and alternatives of the examples may be employed to facilitate the effectiveness of optimizing a transportation scheme.

The examples described herein are merely illustrative, as numerous other embodiments may be implemented without departing from the spirit and scope of the exemplary embodiments of the present invention. Moreover, while certain features of the invention may be shown on only certain embodiments or configurations, these features may be exchanged, added, and removed from and between the various embodiments or configurations while remaining within the scope of the invention. Likewise, methods described and disclosed may also be performed in various sequences, with some or all of the disclosed steps being performed in a different order than described while still remaining within the spirit and scope of the present invention.

We claim:

1. A method for transporting bulk materials, comprising:
(I) receiving a data set comprising:
(a) an identification of a plurality of supply locations and a plurality of demand locations;
(b) for each supply location, information relating to its physical location and bulk material availability;
(c) for each demand location, information relating to its physical location and bulk material requirements;
(d) an identification of a fleet of vehicles for transporting bulk materials from the supply locations to the demand locations, and information relating to the availability, cost, and capacity of each vehicle;
(e) for each type of bulk material, information relating to the economic value of the type of bulk material according to its potential dispositions;
(f) information relating to the cost of transporting the bulk materials;
(II) formulating a mathematical model comprising an objective function for net profit margin and a plurality of constraints;
wherein the objective function includes decision variables relating to supply nomination parameters, allocation of the supply of bulk materials to the requirements at the demand locations, and voyages by the vehicles between the supply locations and the demand locations;
(III) populating the mathematical model with data from the data set or parameters calculated using data from the data set;
(IV) obtaining one or more solutions to the mathematical model; and
(V) physically transporting the bulk materials based upon a solution to the mathematical model.

2. The method of claim 1, wherein the decision variables relating to supply nomination parameters include decision variables for the types of bulk material to be nominated, the volume of bulk materials to be nominated, and the schedule for loading the bulk materials at the supply locations.

3. The method of claim 1, wherein the decision variables relating to the allocation of the supply of bulk materials include decision variables for the discharge volumes of the bulk materials at each of the demand locations.

4. The method of claim 1, wherein the decision variables relating to the voyages by the vehicles include decision variables for the assignment of vehicles to the voyages and the sequence of supply and demand location visits, loadings, and discharges for each of the vehicles.

5. The method of claim 1, wherein the information relating to the bulk material availability at the supply locations includes information relating to types of bulk material available, volumes of bulk materials available, and temporal availability of bulk materials.

6. The method of claim 1, wherein the information relating to the bulk material requirements at the demand locations includes information relating to demand location segregations, types of bulk materials that are acceptable for each segregation, inventory capacity of each segregation, processing rates of each segregation, types of bulk material required, volumes of bulk material required including tolerances, and temporal requirements for bulk material delivery.

7. The method of claim 1, wherein the information relating to the availability of the vehicles include the temporal availability and physical location of the vehicles.

8. The method of claim 1, wherein the data set further comprises one or more of the following information relating to:
vehicle restrictions at the supply locations, demand locations, or voyages;
speed and fuel consumption of the vehicles;
vehicle costs;
the categorization of supply locations and demand locations into geographic regions;
limits for each supply location and demand location;
fees or tariffs for each supply location and demand location;
voyage fees, tariffs, or tolls;
freight costs; and
leg distances.

9. The method of claim 8, wherein the data set further comprises one or more of the following information relating to:
spot costs and term costs;
draft limits, cargo limits, and berth limits for each supply location and demand location;
canal tolls;
drop and pick or repackaging fees; and
pipeline costs.

10. The method of claim 1, wherein the constraints for the mathematical model include constraints relating to processing limitations at the demand locations.

11. The method of claim 10, wherein the constraints relating to processing limitations include constraints for blending specifications or blend-down ratios.

12. The method of claim 1, wherein the constraints for the mathematical model include the ratability of the supply nominations.

13. The method of claim 1, wherein the data set includes information relating to the categorization of demand locations into geographic regions, and wherein the constraints for the MIP model include requirements relating to minimum or maximum amounts of cargo, with respect to each geographic region, to be delivered by the vehicles or retained at the region.

14. The method of claim 1, wherein the mathematical model is a mixed-integer programming model.

15. The method of claim 1, wherein the mixed-integer programming model is a mixed-integer linear programming model.

16. The method of claim 1, wherein obtaining the one or more solutions to the mathematical model comprises the steps of:
obtaining a first solution by removing one or more groups of constraints of the mathematical model; and
obtaining a second solution by solving a subproblem of the mathematical model in which, based on the first solution, one or more decision variables of the mathematical model are held constant or are disregarded.

17. The method of claim 16, wherein the constraints for the mathematical model include inventory constraints and blending constraints, and wherein the first solution is obtained by ignoring the inventory constraints, the blending constraints, or both.

18. The method of claim 16, wherein obtaining the one or more solutions to the mathematical model further comprises the steps of:
obtaining a third solution by a local search heuristic using the second solution as an initial feasible solution; and
obtaining a fourth solution by reducing the solution space for the mathematical model.

19. The method of claim 18, wherein the second solution is obtained by a construction heuristic, the third solution is obtained by an improvement heuristic, and the fourth solution is obtained by a solution space reduction.

20. The method of claim 16, wherein the first solution is an upper bound for the objective function value and the second solution is a lower bound for the objective function value.

21. The method of claim 16, wherein the first solution includes a determination of a selected set of voyages, and wherein the second solution is obtained by solving a subproblem of the mathematical model in which decision variables relating to the non-selected voyages are disregarded.

22. A computer apparatus comprising:
(I) a memory device storing a data file containing:
(a) an identification of a plurality of supply locations and a plurality of demand locations;
(b) for each supply location, information relating to its physical location and bulk material availability;
(c) for each demand location, information relating to its physical location and bulk material requirements;
(d) an identification of a fleet of vehicles for transporting bulk materials from the supply locations to the demand locations, and information relating to the availability, cost, and capacity of each vehicle;
(e) for each type of bulk material, information relating to the economic value of the type of bulk material;
(f) information relating to the cost of transporting the bulk materials;
(II) a modeling application executable by the computer apparatus to populate a mathematical model that comprises an objective function for net profit margin and a plurality of constraints;
wherein the objective function includes decision variables relating to supply nomination parameters, allocation of the supply of bulk materials to the requirements at the demand locations, and voyages by the vehicles between the supply locations and the demand locations;
(III) a solver operable by the computer apparatus to obtain one or more solutions to the mathematical model.

23. The computer apparatus of claim 22, further comprising a display for displaying an output based on a solution to the mathematical model.

24. A non-transitory computer-readable storage medium containing a program of instructions executable by a computer to perform method steps for determining the transportation of bulk materials, the method steps comprising:
(I) reading a data file comprising:
(a) an identification of a plurality of supply locations and a plurality of demand locations;
(b) for each supply location, information relating to its physical location and bulk material availability;
(c) for each demand location, information relating to its physical location and bulk material requirements;
(d) an identification of a fleet of vehicles for transporting bulk materials from the supply locations to the demand locations, and information relating to the availability, cost, and capacity of each vehicle;
(e) for each type of bulk material, information relating to the economic value of the type of bulk material;
(f) information relating to the cost of transporting the bulk materials;
(II) using the data file to populate a mathematical model that comprises an objective function for net profit margin and a plurality of constraints;
wherein the objective function includes decision variables relating to supply nomination parameters, allocation of the supply of bulk materials to the requirements at the demand locations, and voyages by the vehicles between the supply locations and the demand locations;
(III) obtaining one or more solutions to the mathematical model.

25. The computer-readable storage medium of claim 24, wherein the method steps further comprise creating an output based on a solution to the mathematical model.
